(19) United States
(12) Patent Application Publication
(10) Pub. No.: US 2025/0238714 A1
(43) Pub. Date: Jul. 24, 2025

(54) MODELING PETROPHYSICAL PROPERTIES IN A SUBSURFACE FORMATION

(71) Applicant: Saudi Arabian Oil Company, Dhahran (SA)

(72) Inventors: Aun Al Ghaithi, Dhahran (SA); Charles Bradford, Wesley Chapel, FL (US)

(21) Appl. No.: 18/421,403

(22) Filed: Jan. 24, 2024

(51) Int. Cl. G06N 20/00

(52) U.S. Cl. CPC G06N 20/00

(57) ABSTRACT

This disclosure describes systems and methods for predicting permeability in a subsurface formation. A the method includes obtaining well log data and core sample data from wells in the subsurface formation; selecting input features from the well log data based on a statistical analysis of the well log data and the core sample data; forming a training dataset including the input features and corresponding core sample data as labeled output data; training, using the training dataset, a machine learning model; and predicting permeability data for non-cored wells in the subsurface formation based on the trained machine learning model.

### TECHNICAL FIELD

The present disclosure relates to methods and systems for petrophysical modeling of a subsurface formation.

### BACKGROUND

Petrophysics includes the study of rock properties in a subsurface formation and interactions with fluids. Petrophysical properties of the subsurface formation can be measured through well logging and core sampling. Petrophysical properties can include porosity, permeability, water saturation, lithology, and capillary pressure, among others. In the oil and gas industry, for example, petrophysicists model the subsurface formation to determine accumulation and migration of hydrocarbons within the subsurface.

### SUMMARY

This disclosure describes systems and methods for predicting permeability in the subsurface formation using a trained machine learning model. A data processing system (e.g., a computing system or a control system) obtains well log data and core sample data from wells in the subsurface formation. The data processing system selects input features for the machine learning model from the well log data based on a statistical analysis of the well log data and the core sample data. The data processing system forms a training dataset including the input features and corresponding core sample data as labeled output data. The data processing system trains the machine learning model using the training dataset. The data processing system predicts permeability data for non-cored wells in the subsurface formation based on the trained machine learning model.

Implementations of the systems and methods of this disclosure can provide various technical benefits. Permeability values can be predicted for wells that do not have measured permeability data, for example, wells without core sample data. Removing outlier data can reduce skew in the permeability predictions. Selecting relevant input features from the well log and core sample data using statistical analysis can also reduce skew in the permeability predictions. The predicted permeability data improves the characterization of reservoirs in the subsurface resulting in improved estimates of the amount of hydrocarbons in the subsurface. The amount of hydrocarbons in the subsurface drives decisions on where to drill additional wells in the subsurface and how the additional wells are drilled. The predicted permeability data can further be utilized in 3D geomodelling and reservoir simulation studies for history matching with hydrocarbon production data. The 3D geomodelling and reservoir simulations based on the predicted permeability data are more accurate than 3D geomodelling and reservoir simulations based on other methods due to the more accurate predicted permeability data. Drilling decision can be made based on the 3D geomodelling and reservoir simulations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates an example wireline operation for collecting well log and core sample data from a subsurface formation.

FIG. 2 is a flowchart of an example method of predicting permeability in a subsurface formation.

FIG. 3 is an example plot of core permeability and core porosity from wells in a subsurface formation.

FIG. 4A is a composite plot of histograms of well log data from wells in the subsurface formation.

FIG. 4B is a composite plot of the histograms of FIG. 4A with outlier data removed.

FIG. 5A is an example heat map of correlation factors corresponding to the well logs in FIG. 4A.

FIG. 5B is a heat map of correlation factors corresponding to the well logs in FIG. 4B having outlier data removed.

FIG. 6 is an example plot of accuracy of a neural network during training.

FIGS. 7A-7B are example cross plots of predicted permeability and measured permeability.

FIG. 8 is an example schematic of a neural network.

FIG. 9 is flowchart of another method for predicting permeability in a subsurface formation.

FIG. 10 illustrates hydrocarbon production operations that include field operations and computational operations, according to some implementations.

FIG. 11 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This disclosure describes systems and methods for predicting permeability in the subsurface formation using a trained machine learning model. A data processing system (e.g., a computing system or a control system) obtains well log data and core sample data from wells in the subsurface formation. The data processing system selects input features for the machine learning model from the well log data based on a statistical analysis of the well log data and the core sample data. The data processing system forms a training dataset including the input features and corresponding core sample data as labeled output data. The data processing system trains the machine learning model using the training dataset. The data processing system predicts permeability data for non-cored wells in the subsurface formation based on the trained machine learning model.

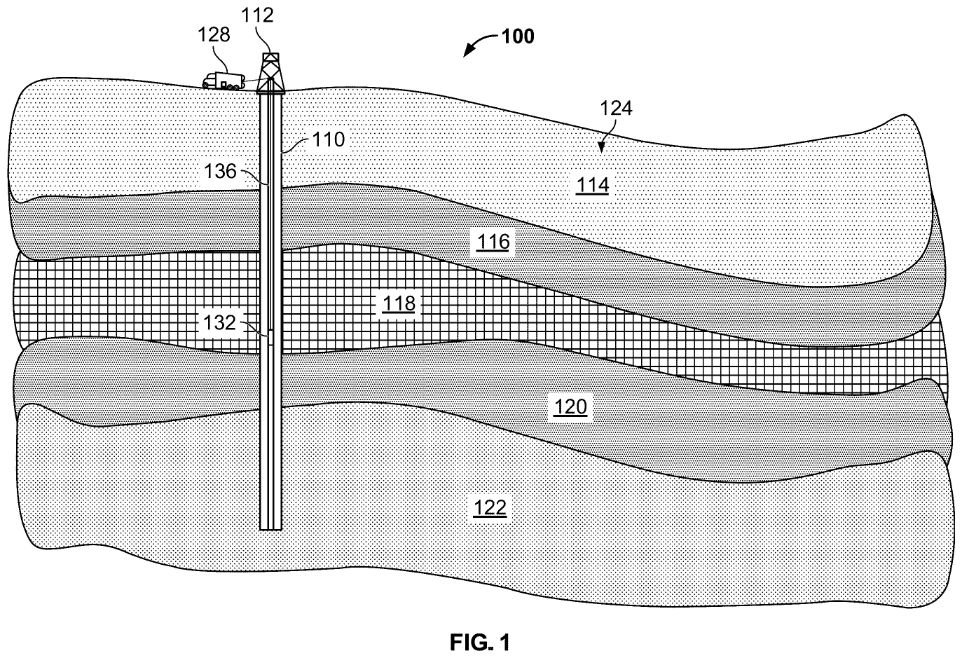

FIG. 1 illustrates a wireline operation 100 (e.g., a well logging operation) in which a wellbore 110 extends downhole from a wellhead 112. The wellbore 110 is a vertical wellbore but wireline operations can also be performed in other wellbores, for example, slanted or horizontal wellbores. In the wireline operation 100, the wellbore 110 penetrates through five layers 114, 116, 118, 120, 122 of a subsurface formation 124. A control truck 128 lowers a logging tool 132 (e.g., a sidewall coring tool) down the wellbore 110 on a wireline 136.

The logging tool 132 is string of one or more instruments with sensors operable to measure petrophysical properties of the subsurface formation 124. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which is typically a function of lithology and rock texture but particularly porosity. The logging tool includes a piezoelectric transmitter and receiver and the time taken for the sound wave to travel the fixed distance between the two is recorded as an interval transit time.

As the logging tool 132 travels downhole, measurements of formation properties are recorded to generate a well log. In the illustrated operation, the data are recorded at the control truck 128 in real-time. Real-time data are recorded directly against measured cable depth. In some well-logging operations, the data is recorded at the logging tool 132 and downloaded later. In this approach, the downhole data and depth data are both recorded against time The two data sets are then merged using the common time base to create an instrument response versus depth log.

In the wireline operation 100, the well logging is performed on a wellbore 110 that has already been drilled. In some operations, well logging is performed in the form of logging while drilling techniques. In these techniques, the sensors are integrated into the drill string and the measurements are made in real-time, during drilled rather than using sensors lowered into a well after drilling.

Using a wireline coring tool, core samples can be obtained in addition to obtaining well logs. A core sample is usually a cylindrical piece of the subsurface formation that is removed by a special drill and brought to the surface. Core samples can be used to measure petrophysical properties of the subsurface formation such as grain size, porosity, permeability, and unconformity. Core samples can be taken from the sidewalls of a drilled well. When sidewall core samples are repeated along the length of the well, the properties measured from the core samples can be compared and correlated with well logging measurements.

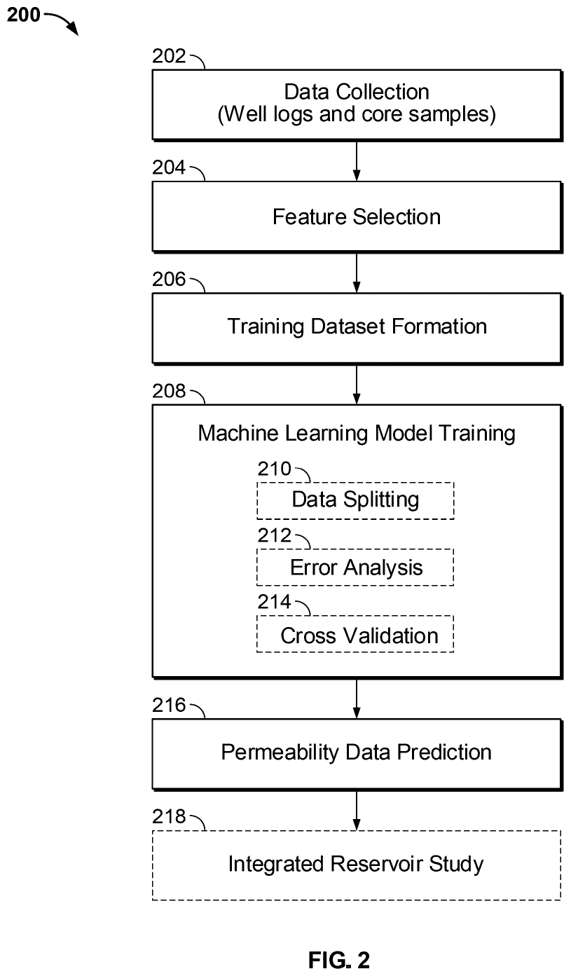

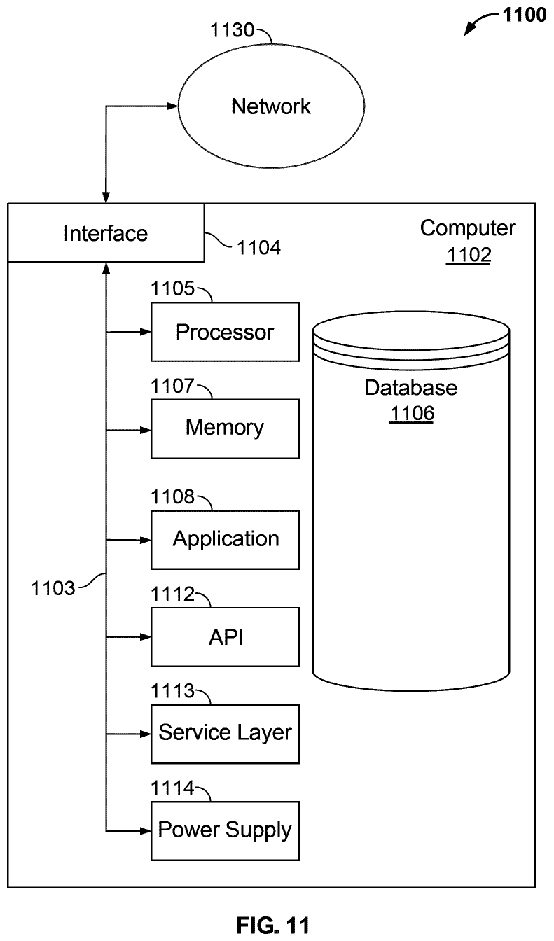

FIG. 2 is a flowchart of an example method 200 for predicting permeability in a subsurface formation. The method 200 can be implemented on a data processing system such as a computer or control system (e.g., the computer system of FIG. 11).

At step 202, the data processing system collects data, including well logs and core samples, from wells in a subsurface formation. For example, well log data and core sample data can be collected during wireline operations, such as wireline operation 100. In some implementations, the data processing system accesses well log data and core sample data from a data store or database. The core sample data can include petrophysical properties for the subsurface formation such as permeability, porosity, and lithology, among other data. The core sample data can include core permeability data obtained, for example, from laboratory measurements of core samples taken from wells in the subsurface formation using industry practices.

At step 204, the data processing system selects features from the well log data for input into the machine learning model. The data processing system selects input features from the well log data based on the statistical analysis of the well log data and the core sample data. For example, the data processing system can determine correlation factors between the well log data and the core sample data. The data processing system can select features that exceed a threshold value in a statistical significance test. For example, the data processing system can select features having a correlation factor above a threshold correlation factor.

In some implementations, the data processing system preprocesses the well log and core sample data to remove missing and/or bad data points. For example, the data processing system can identify data points corresponding to core sample data points having a value below a threshold value. The threshold value can be, for example, a resolution of a measurement instrument used for measuring permeability values of the core samples. The data processing system can remove values below the specified threshold. In some examples, the data processing system can normalize the well log and permeability data sets prior to selecting features.

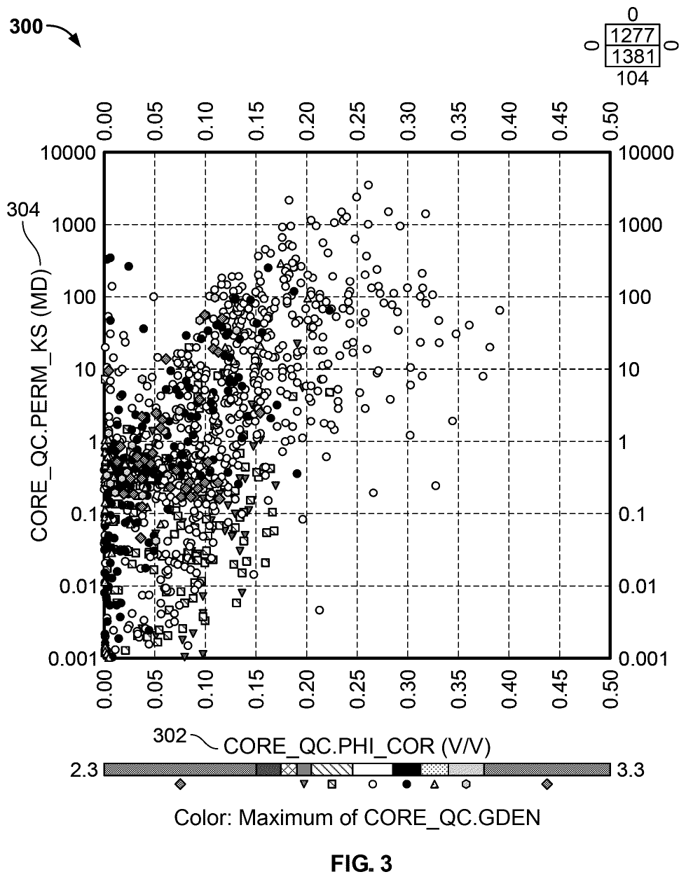

Turning briefly to FIGS. 3-5B, FIG. 3 shows an example plot 300 of core sample data obtained from several wells in a subsurface formation. The plot 300 shows porosity 302 on the X axis and permeability 304 on the Y axis. The data captures reservoir heterogeneity and high permeability zones as indicated by the variation of porosity and permeability values. The reservoir described by plot 300 includes zones with porosities from 0 to 40%. The permeability values vary form 0 millidarcy (mD) to 10000 mD. High permeability zones are zones with a permeability greater than 1 mD. The core data as shown includes stress corrections and depth shifting.

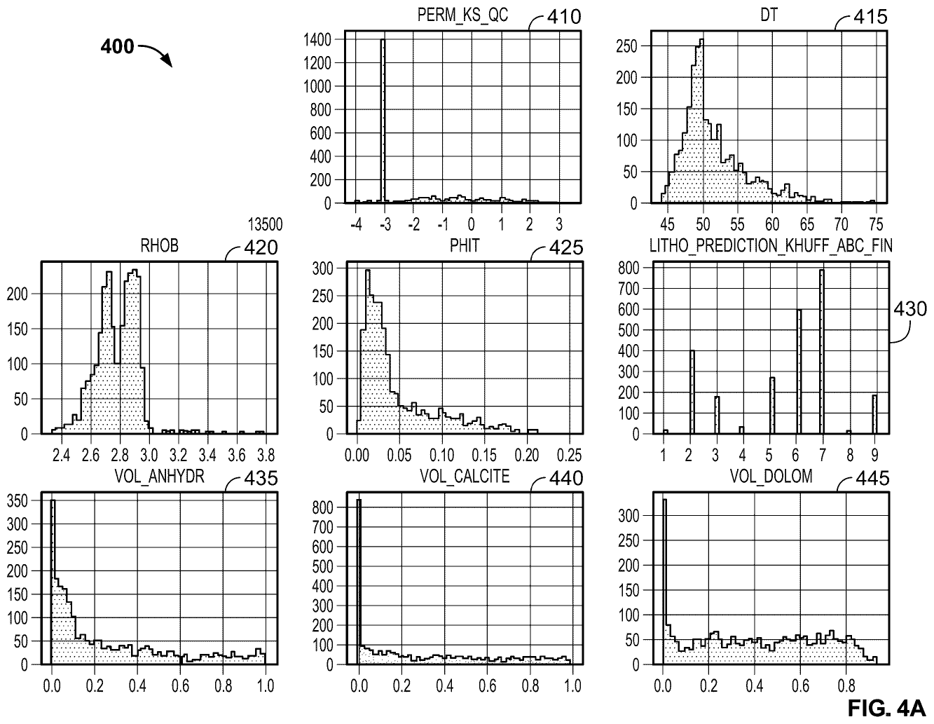

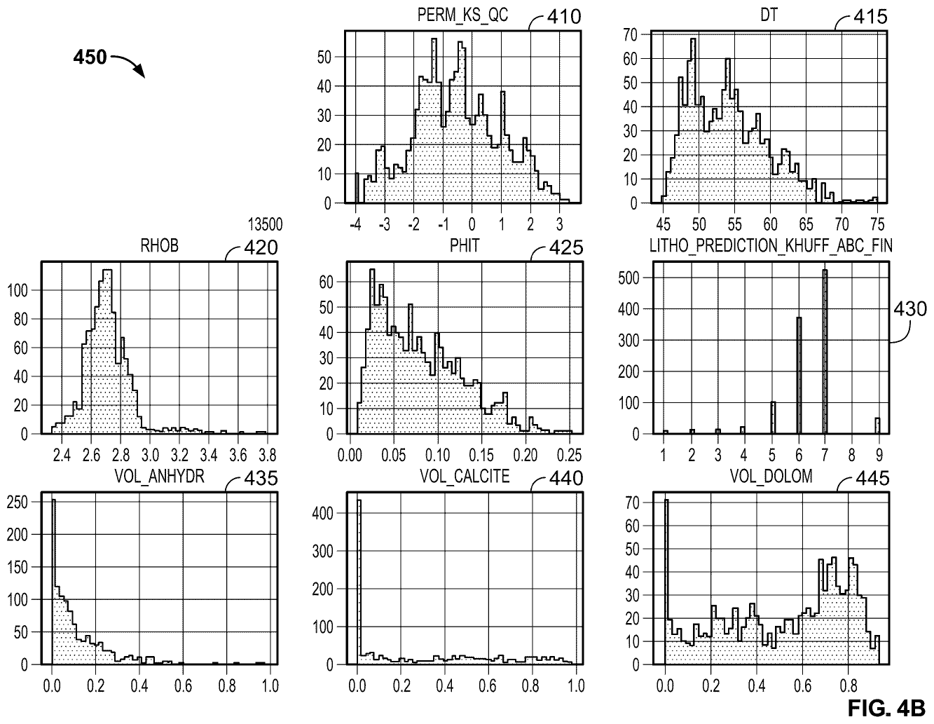

FIG. 4A is a composite plot 400 of histograms representing well log data and core permeability data from wells in the subsurface formation. Plot 410 is a plot of core sample permeability measurements. Plot 415 is a compressional sonic log (DT). Plot 420 shows density data (RHOB). Plot 425 shows total porosity (PHIT). Plot 430 shows lithology facies predictions. Plot 435 shows volume of anhydrite. Plot 440 shows volume of calcite. Plot 445 shows the volume of dolomite.

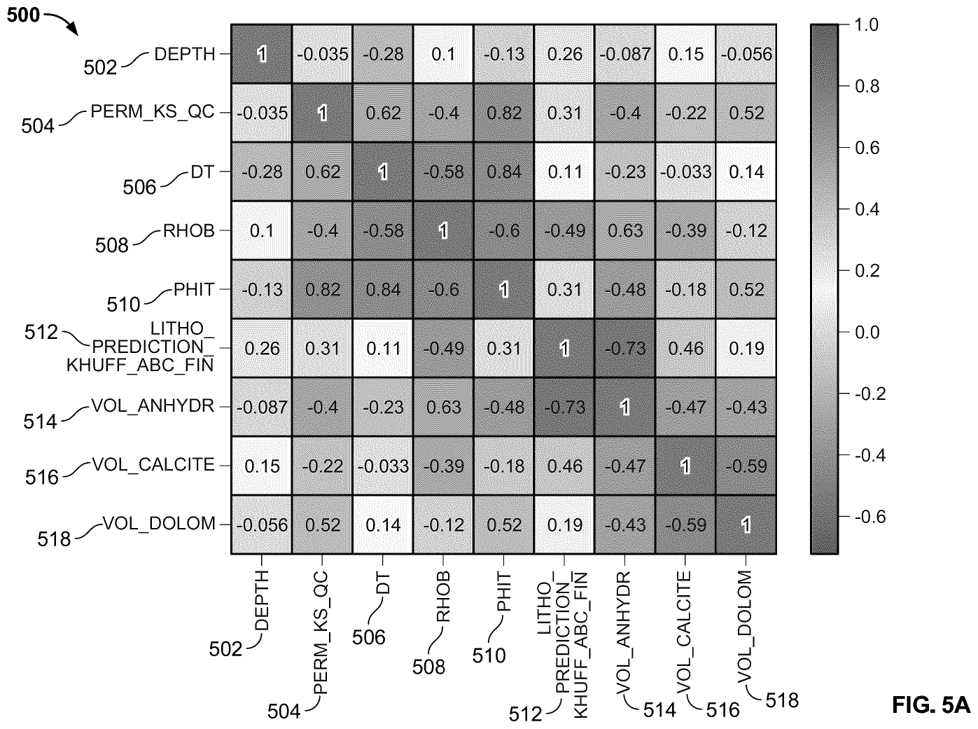

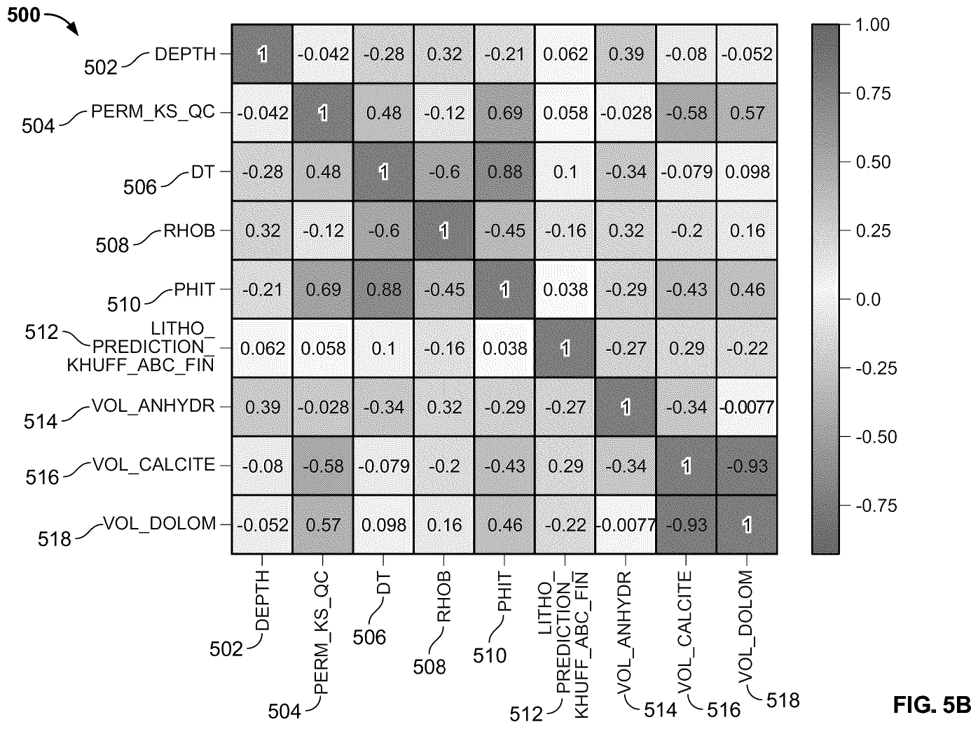

FIG. 4B shows a composite plot 450 of the data from FIG. 4A with the outlier data removed. Well log data points without a corresponding permeability measurement were assigned a permeability value of 0.001 mD. After all missing values were filled. Permeability values of 0.001 mD or less, and the corresponding well log measurements, were removed from the data sets. In this example, the instrument measuring permeability had a resolution of 0.001 milli-Darcy (mD). A comparison of FIGS. 4A-4B reveals that removal of the outliers can alter the shape of the distribution. Removal of these outliers deskews the data as will be discussed in further detail with reference to FIGS. 5A-5B.

FIG. 5A is a heat map 500 showing the correlation factors between the data shown in FIG. 4A, where each row shows the correlation factor with the corresponding column. The correlation factor is equal to 1 on the diagonal where a dataset is correlated with itself. The heat map shows depth 502, measured permeability 504, compressional sonic log (DT) 506, density (RHOB) 508, total porosity (PHIT) 510, lithology facies prediction 512, volume of anhydrite 514, volume of calcite 516, and volume of dolomite 518. Inspecting the row for the measured permeability 504 reveals that when the outlier data is included in the dataset, each of the well logs, shows correlation with the measured permeability.

FIG. 5B shows a heat map 550 of the correlation factor between the data from FIG. 4B that has the outlier data removed. With the outlier data removed, fewer well logs are correlated with the measured permeability 504. In heat map 550, the compressional sound velocity (DT) 506, the total porosity (PHIT) 510, the volume of calcite 516, and the volume of dolomite 518 show the strongest correlation with the measured permeability 504. In this example, the data processing system selects these four well logs as the input features for the machine learning model.

Returning to FIG. 2, at step 206, the data processing system forms a training data set from the well log data and the core sample data. For example, the data processing system forms the training dataset by extracting the input features selected in step 204 from the well log data. The data processing system includes the core sample data corresponding to the selected well log data as labeled output data.

At step 208, the data processing system trains the machine learning model using the training data set. For example, the data processing system provides the input features in the training dataset to the machine learning model in a forward propagation step. The data processing system generates predicted values based on the weights of the machine learning model. The data processing system determines a loss function between the predicted values and the labeled output data. In a backward propagation step, the data processing system adjusts the weights of the machine learning model using an optimization algorithm (e.g., steepest descent, and Adam optimization) based on the values of the loss function. The machine learning model can be, for example, a neural network or a deep neural network (e.g., a neural network including more than one hidden layer). Other machine learning models can also be used.

In some implementations, training the machine learning model includes one or more sub steps such as splitting the data (step 210), error analysis (step 212), and cross validation (step 214). At step 210, the data processing system splits the data into a training set and a testing set. The data processing system can, for example, split the training data set putting 80% of the data in the training set and 20% of the data into the testing set using random selection. The data processing system uses the training set to train the machine learning model, and the testing set for evaluating the performance of the machine learning model.

At step 212, the data processing system performs error analysis to evaluate the performance of the machine learning model. For example, the data processing system can use an evaluation metric such as root mean squared error, the coefficient of determination, R-squared value, or the correlation coefficient. If the data processing system determines that the machine learning model has not performed adequately, the data processing system can adjust hyperparameters of the machine learning model and retrain the machine learning model using the training dataset.

In some implementations, at step 214, the data processing system performs cross validation during training of the machine learning model. Cross validation includes iteratively training the machine learning model. The data processing system resamples the training set and the testing set (e.g., generates a different split of the training dataset) before each iteration of training. For example, the data processing system can perform cross validation using a k-folds cross validation, a holdout cross validation, or a repeated random sub-sampling cross validation. Cross validation can increase the robustness of the machine learning model as compared with not performing cross validation. A robust model can perform well on the training data and the testing data.

In an example implementation, the machine learning model included a neural network with two hidden layers. The first hidden layer included 32 neurons and the second hidden layer included 12 neurons. An Adam optimizer was used to adjust the weights associated with each neuron during training. The hyperparameters (e.g., number of layers, optimizer, number of neurons) of the neural network were tuned to obtain the best results for the dataset during training and testing.

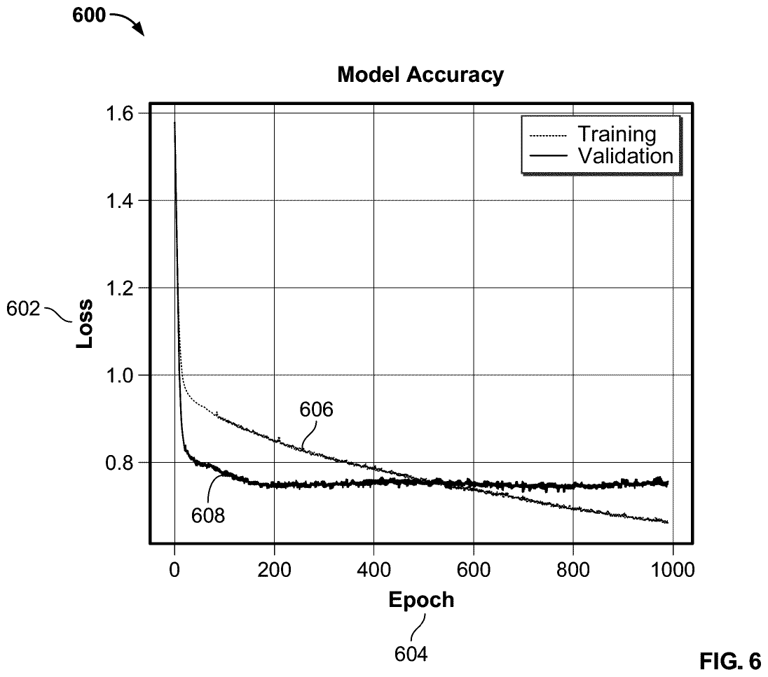

FIG. 6 is a plot 600 of the model accuracy as measured by the value of the loss function 602 versus epoch 604 for the neural network of the example implementation. The neural network was trained for 1000 epochs. Data is shown for the training set 606 (80% of training data, randomly selected) and the testing set 608 (20% of training data). After about 200 epochs the value of the loss function stabilized reaching a minimum value on the testing data 608.

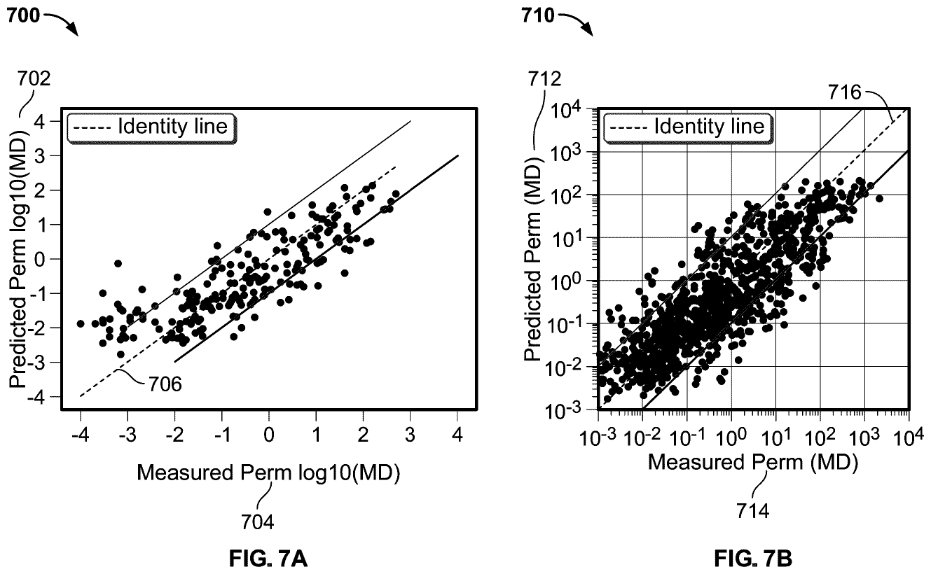

FIG. 7A is a cross plot 700 of predicted permeability 702 based on the trained machine learning model versus measured permeability 704 with the identity line 706. Plot 700 shows the data from the testing set. The predicted permeability 702 had an 83% correlation with the measured permeability 704.

FIG. 7B is a cross plot 710 showing all of the data from the training dataset (excluding the outliers). Cross plot 710 shows predicted permeability 712 on the Y axis and measured permeability 714 on the X axis with dashed identity line 716.

Turning back to FIG. 2, at step 216, the data processing system predicts permeability data for wells in the subsurface formation based on the trained machine learning model. The data processing system can predict permeability values for wells that do not have core samples. For example, the non-cored wells do not need to have special or routine core samples or core analysis. In some implementations, the data processing system predicts permeability values for non-cored wells in every reservoir zone in the subsurface formation that have well log data corresponding to the selected input features. In some implementations, the data processing system can propagate the predicted permeability values to areas in the subsurface formation surrounding the wells using the machine learning model.

In some implementations, the data processing system determines a saturation height function for the subsurface formation based on the predicted permeability data. The saturation height function can represent a saturation of fluids in the reservoir for a given height above the free water level. In some implementations, the data processing system determines a petrophysical rock type of the subsurface formation based on the permeability data.

In some implementations, at step 218, the data processing system uses the predicted permeability data in an integrated reservoir study (IRS) to determine hydrocarbon reserves in the subsurface formation. The IRS integrates data from multiple sources to estimate the amount of hydrocarbons in a reservoir. For example, the IRS can be used to determine reserves in the subsurface formation during an annual reserve review and/or certification. In some implementations, the data processing system generates commands to control production equipment to produce hydrocarbons from the subsurface formation based on the determined amount of hydrocarbon reserves in the subsurface formation.

In some implementations, the data processing system can use the predicted permeability data to produce a 3D reservoir model. In some implementations, the data processing system uses the predicted permeability data to perform simulation and history matching for hydrocarbon production data.

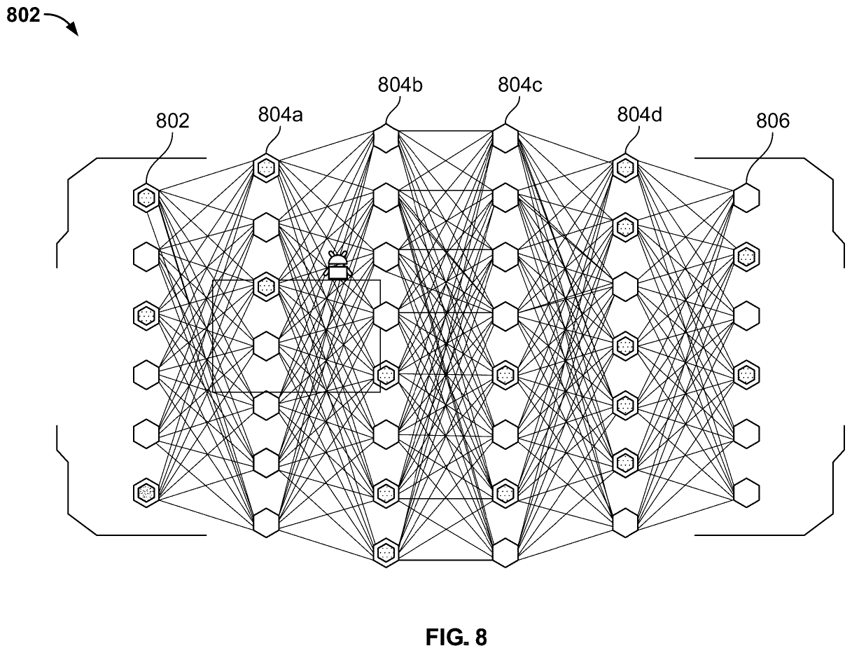

FIG. 8 shows a schematic of a neural network 800. The neural network 800 has an input layer 802. The neural network 800 also includes four hidden layers 804a-d, and the neural network 800 has an output layer 806. The neural network 800 is a fully connected neural network (e.g., each node in a given layer is connected with each node in the preceding and succeeding layers). For example, the six nodes in the input layer 802 are each connected with the seven nodes in the first hidden layer 804a. Each node in the hidden layer 804a is connected with each node in the hidden layer 804b. Neural networks can have a variety of architectures with hyperparameters, such as number of hidden layers and number of neurons per layer, that can be tuned or selected by a data processing system to optimize performance of the neural network in a particular implementation.

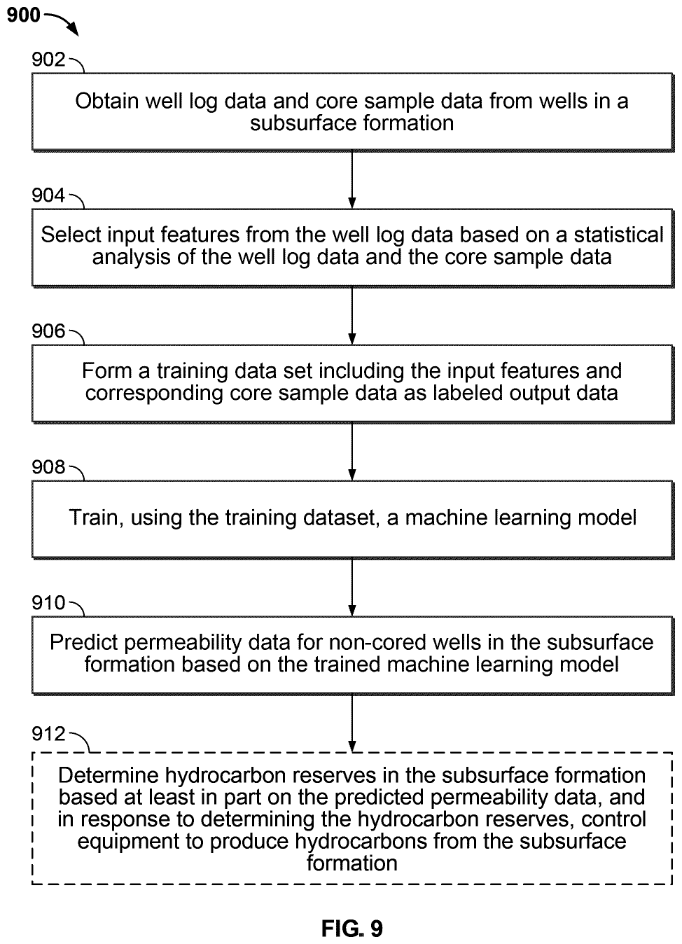

FIG. 9 is a flowchart of another method 900 for predicting permeability in a subsurface formation. At step 902, a data processing system obtains well log data and core sample data from wells in the subsurface formation.

At step 904, the data processing system selects input features from the well log data based on a statistical analysis of the well log data and the core sample data. In some implementations, the statistical analysis includes determining a correlation factor between the well log data and the core sample data. In some implementations, the statistical analysis includes removing data points from the well log data corresponding to permeability core sample data having values less than a specified threshold. In some implementations, the specified threshold includes a resolution of a measurement instrument (e.g., a permeability measurement instrument). In some implementations, the input features include one or more of a compressional sonic log, a total porosity log, a volume of calcite log, and a volume of dolomite log.

At step 906, the data processing system forms a training dataset including the input features and corresponding core sample data as labeled output data.

At step 908, the data processing system trains a machine learning model using the training dataset. In some implementations, the machine learning model is a neural network. In some implementations, training the machine learning model includes splitting the training dataset into a training set and a testing set based on random selection. In some implementations, training the machine learning model includes performing cross validation by iteratively training the machine learning model, and resampling the training set and the testing set before each iteration.

At step 910, the data processing system predicts permeability data for non-cored wells in the subsurface formation based on the trained machine learning model.

In some implementations, at step 912, the data processing system determines hydrocarbon reserves in the subsurface formation based at least in part on the predicted permeability data. In response to determining the hydrocarbon reserves, the data processing system controls equipment to produce hydrocarbons from the subsurface formation.

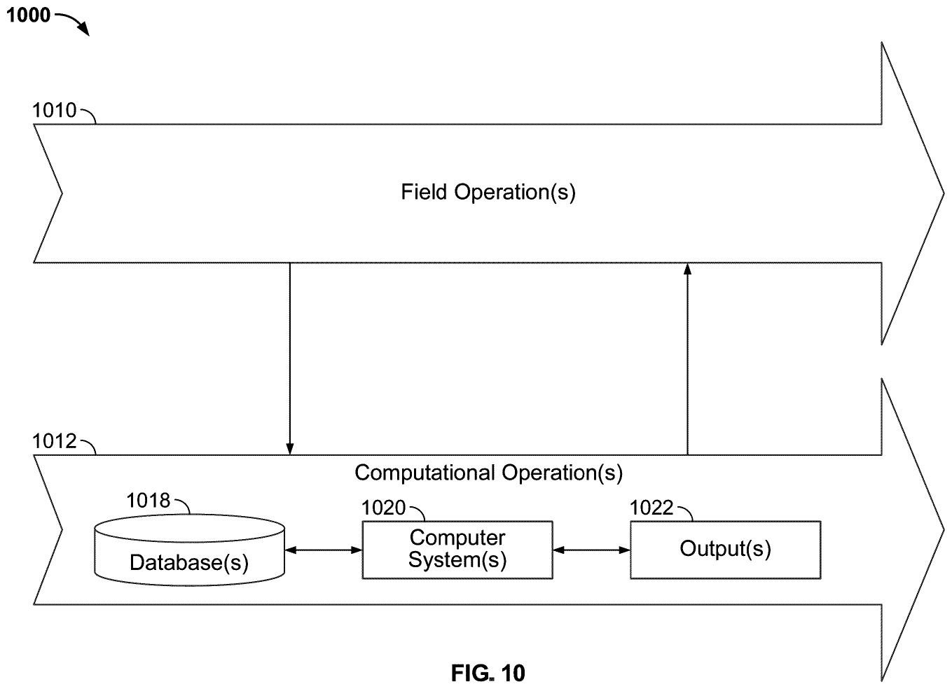

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure (e.g., the method 100 or method 900) can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 11 is a block diagram of an example computer system 1100 used to provide computational functionalities associated with described algorithms, methods, functions, processes, flows, and procedures described in the present disclosure, according to some implementations of the present disclosure. The illustrated computer 1102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1102 can include input devices such as keypads, keyboards, and touch screens that can accept user information. Also, the computer 1102 can include output devices that can convey information associated with the operation of the computer 1102. The information can include digital data, visual data, audio information, or a combination of information. The information can be presented in a graphical user interface (UI) (or GUI).

The computer 1102 can serve in a role as a client, a network component, a server, a database, a persistency, or components of a computer system for performing the subject matter described in the present disclosure. The illustrated computer 1102 is communicably coupled with a network 1130. In some implementations, one or more components of the computer 1102 can be configured to operate within different environments, including cloud-computing-based environments, local environments, global environments, and combinations of environments.

At a high level, the computer 1102 is an electronic computing device operable to receive, transmit, process, store, and manage data and information associated with the described subject matter. According to some implementations, the computer 1102 can also include, or be communicably coupled with, an application server, an email server, a web server, a caching server, a streaming data server, or a combination of servers.

The computer 1102 can receive requests over network 1130 from a client application (for example, executing on another computer 1102). The computer 1102 can respond to the received requests by processing the received requests using software applications. Requests can also be sent to the computer 1102 from internal users (for example, from a command console), external (or third) parties, automated applications, entities, individuals, systems, and computers.

Each of the components of the computer 1102 can communicate using a system bus 1103. In some implementations, any or all of the components of the computer 1102, including hardware or software components, can interface with each other or the interface 1104 (or a combination of both), over the system bus 1103. Interfaces can use an application programming interface (API) 1112, a service layer 1113, or a combination of the API 1112 and service layer 1113. The API 1112 can include specifications for routines, data structures, and object classes. The API 1112 can be either computer-language independent or dependent. The API 1112 can refer to a complete interface, a single function, or a set of APIs.

The service layer 1113 can provide software services to the computer 1102 and other components (whether illustrated or not) that are communicably coupled to the computer 1102. The functionality of the computer 1102 can be accessible for all service consumers using this service layer. Software services, such as those provided by the service layer 1113, can provide reusable, defined functionalities through a defined interface. For example, the interface can be software written in JAVA, C++, or a language providing data in extensible markup language (XML) format. While illustrated as an integrated component of the computer 1102, in alternative implementations, the API 1112 or the service layer 1113 can be stand-alone components in relation to other components of the computer 1102 and other components communicably coupled to the computer 1102. Moreover, any or all parts of the API 1112 or the service layer 1113 can be implemented as child or sub-modules of another software module, enterprise application, or hardware module without departing from the scope of the present disclosure.

The computer 1102 includes an interface 1104. Although illustrated as a single interface 1104 in FIG. 11, two or more interfaces 1104 can be used according to particular needs, desires, or particular implementations of the computer 1102 and the described functionality. The interface 1104 can be used by the computer 1102 for communicating with other systems that are connected to the network 1130 (whether illustrated or not) in a distributed environment. Generally, the interface 1104 can include, or be implemented using, logic encoded in software or hardware (or a combination of software and hardware) operable to communicate with the network 1130. More specifically, the interface 1104 can include software supporting one or more communication protocols associated with communications. As such, the network 1130 or the interface's hardware can be operable to communicate physical signals within and outside of the illustrated computer 1102.

The computer 1102 includes a processor 1105. Although illustrated as a single processor 1105 in FIG. 11, two or more processors 1105 can be used according to particular needs, desires, or particular implementations of the computer 1102 and the described functionality. Generally, the processor 1105 can execute instructions and can manipulate data to perform the operations of the computer 1102, including operations using algorithms, methods, functions, processes, flows, and procedures as described in the present disclosure.

The computer 1102 also includes a database 1106 that can hold data for the computer 1102 and other components connected to the network 1130 (whether illustrated or not). For example, database 1106 can be an in-memory, conventional, or a database storing data consistent with the present disclosure. In some implementations, database 1106 can be a combination of two or more different database types (for example, hybrid in-memory and conventional databases) according to particular needs, desires, or particular implementations of the computer 1102 and the described functionality. Although illustrated as a single database 1106 in FIG. 11, two or more databases (of the same, different, or combination of types) can be used according to particular needs, desires, or particular implementations of the computer 1102 and the described functionality. While database 1106 is illustrated as an internal component of the computer 1102, in alternative implementations, database 1106 can be external to the computer 1102.

The computer 1102 also includes a memory 1107 that can hold data for the computer 1102 or a combination of components connected to the network 1130 (whether illustrated or not). Memory 1107 can store any data consistent with the present disclosure. In some implementations, memory 1107 can be a combination of two or more different types of memory (for example, a combination of semiconductor and magnetic storage) according to particular needs, desires, or particular implementations of the computer 1102 and the described functionality. Although illustrated as a single memory 1107 in FIG. 11, two or more memories 1107 (of the same, different, or combination of types) can be used according to particular needs, desires, or particular implementations of the computer 1102 and the described functionality. While memory 1107 is illustrated as an internal component of the computer 1102, in alternative implementations, memory 1107 can be external to the computer 1102.

The application 1108 can be an algorithmic software engine providing functionality according to particular needs, desires, or particular implementations of the computer 1102 and the described functionality. For example, application 1108 can serve as one or more components, modules, or applications. Further, although illustrated as a single application 1108, the application 1108 can be implemented as multiple applications 1108 on the computer 1102. In addition, although illustrated as internal to the computer 1102, in alternative implementations, the application 1108 can be external to the computer 1102.

The computer 1102 can also include a power supply 1114. The power supply 1114 can include a rechargeable or non-rechargeable battery that can be configured to be either user- or non-user-replaceable. In some implementations, the power supply 1114 can include power-conversion and management circuits, including recharging, standby, and power management functionalities. In some implementations, the power-supply 1114 can include a power plug to allow the computer 1102 to be plugged into a wall socket or a power source to, for example, power the computer 1102 or recharge a rechargeable battery.

There can be any number of computers 1102 associated with, or external to, a computer system containing computer 1102, with each computer 1102 communicating over network 1130. Further, the terms “client,” “user,” and other appropriate terminology can be used interchangeably, as appropriate, without departing from the scope of the present disclosure. Moreover, the present disclosure contemplates that many users can use one computer 1102 and one user can use multiple computers 1102.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described.

Nevertheless, it will be understood that various modifications may be made without departing from the spirit and scope of this disclosure. Accordingly, other embodiments are within the scope of the following claims.

### Examples

In an example implementation, a method for predicting permeability in a subsurface formation includes obtaining well log data and core sample data from wells in the subsurface formation; selecting input features from the well log data based on a statistical analysis of the well log data and the core sample data; forming a training dataset including the input features and corresponding core sample data as labeled output data; training, using the training dataset, a machine learning model; and predicting permeability data for non-cored wells in the subsurface formation based on the trained machine learning model.

An aspect combinable with the example implementation includes determining hydrocarbon reserves in the subsurface formation based at least in part on the predicted permeability data; and in response to determining the hydrocarbon reserves, controlling equipment to produce hydrocarbons from the subsurface formation.

In another aspect combinable with any of the previous aspects, the machine learning model includes a neural network.

In another aspect combinable with any of the previous aspects, the statistical analysis includes determining a correlation factor between the well log data and the core sample data.

In another aspect combinable with any of the previous aspects, the statistical analysis includes removing data points from the well log data corresponding to permeability core sample data having values less than a specified threshold.

In another aspect combinable with any of the previous aspects, the specified threshold includes a resolution of a measurement instrument.

In another aspect combinable with any of the previous aspects, the input features include one or more of a compressional sonic log, a total porosity log, a volume of calcite log, and a volume of dolomite log.

In another aspect combinable with any of the previous aspects, training the machine learning model includes splitting the training dataset into a training set and a testing set based on random selection.

In another aspect combinable with any of the previous aspects, training the machine learning model includes performing cross validation by iteratively training the machine learning model; and resampling the training set and the testing set before each iteration.

In another example implementations, a system predicting permeability in a subsurface formation includes at least one processor and a memory storing instructions that, when executed by the at least one processor, cause the at least one processor to perform operations including obtaining well log data and core sample data from wells in the subsurface formation; selecting input features from the well log data based on a statistical analysis of the well log data and the core sample data; forming a training dataset including the input features and corresponding core sample data as labeled output data; training, using the training dataset, a machine learning model; and predicting permeability data for non-cored wells in the subsurface formation based on the trained machine learning model.

In an aspect combinable with the example implementation, the operations further include determining hydrocarbon reserves in the subsurface formation based at least in part on the predicted permeability data; and in response to determining the hydrocarbon reserves, controlling equipment to produce hydrocarbons from the subsurface formation.

In another aspect combinable with any of the previous aspects, the machine learning model includes a neural network.

In another aspect combinable with any of the previous aspects, the statistical analysis includes determining a correlation factor between the well log data and the core sample data.

In another aspect combinable with any of the previous aspects, the statistical analysis further includes removing data points from the well log data corresponding to permeability core sample data having values less than a specified threshold.

In another aspect combinable with any of the previous aspects, the input features include one or more of a compressional sonic log, a total porosity log, a volume of calcite log, and a volume of dolomite log.

In another aspect combinable with any of the previous aspects, training the machine learning model includes splitting the training dataset into a training set and a testing set based on random selection; performing cross validation by iteratively training the machine learning model; and resampling the training set and the testing set before each iteration.

In another example implementations, one or more non-transitory machine-readable storage devices storing instructions for predicting permeability in a subsurface formation, the instructions being executable by one or more processors, to cause performance of operations including obtaining well log data and core sample data from wells in the subsurface formation; selecting input features from the well log data based on a statistical analysis of the well log data and the core sample data; forming a training dataset including the input features and corresponding core sample data as labeled output data; training, using the training dataset, a machine learning model; and predicting permeability data for non-cored wells in the subsurface formation based on the trained machine learning model.

In an aspect combinable with the example implementation, the operations include determining hydrocarbon reserves in the subsurface formation based at least in part on the predicted permeability data; and in response to determining the hydrocarbon reserves, controlling equipment to produce hydrocarbons from the subsurface formation.

In another aspect combinable with any of the previous aspects, the machine learning model includes a neural network.

In another aspect combinable with any of the previous aspects, the statistical analysis includes determining a correlation factor between the well log data and the core sample data; and removing data points from the well log data corresponding to permeability core sample data having values less than a specified threshold.

1. A method for predicting permeability in a subsurface formation, the method comprising:
obtaining well log data and core sample data from wells in the subsurface formation;
selecting input features from the well log data based on a statistical analysis of the well log data and the core sample data;
forming a training dataset including the input features and corresponding core sample data as labeled output data;
training, using the training dataset, a machine learning model; and
predicting permeability data for non-cored wells in the subsurface formation based on the trained machine learning model.

2. The method of claim 1, further comprising:
determining hydrocarbon reserves in the subsurface formation based at least in part on the predicted permeability data; and
in response to determining the hydrocarbon reserves, controlling equipment to produce hydrocarbons from the subsurface formation.

3. The method of claim 1, wherein the machine learning model comprises a neural network.

4. The method of claim 1, wherein the statistical analysis comprises: determining a correlation factor between the well log data and the core sample data.

5. The method of claim 4, wherein the statistical analysis further comprises:
removing data points from the well log data corresponding to permeability core sample data having values less than a specified threshold.

6. The method of claim 5, wherein the specified threshold comprises a resolution of a measurement instrument.

7. The method of claim 1, wherein the input features comprise one or more of a compressional sonic log, a total porosity log, a volume of calcite log, and a volume of dolomite log.

8. The method of claim 1, wherein training the machine learning model comprises:
splitting the training dataset into a training set and a testing set based on random selection.

9. The method of claim 8, wherein training the machine learning model comprises:
performing cross validation by iteratively training the machine learning model; and resampling the training set and the testing set before each iteration.

10. A system predicting permeability in a subsurface formation, the system comprising:
at least one processor and a memory storing instructions that, when executed by the at least one processor, cause the at least one processor to perform operations comprising:
obtaining well log data and core sample data from wells in the subsurface formation;
selecting input features from the well log data based on a statistical analysis of the well log data and the core sample data;
forming a training dataset including the input features and corresponding core sample data as labeled output data;
training, using the training dataset, a machine learning model; and
predicting permeability data for non-cored wells in the subsurface formation based on the trained machine learning model.

11. The system of claim 10, wherein the operations further comprise:
determining hydrocarbon reserves in the subsurface formation based at least in part on the predicted permeability data; and
in response to determining the hydrocarbon reserves, controlling equipment to produce hydrocarbons from the subsurface formation.

12. The system of claim 10, wherein the machine learning model comprises a neural network.

13. The system of claim 10, wherein the statistical analysis comprises:
determining a correlation factor between the well log data and the core sample data.

14. The system of claim 13, wherein the statistical analysis further comprises:
removing data points from the well log data corresponding to permeability core sample data having values less than a specified threshold.

15. The system of claim 10, wherein the input features comprise one or more of a compressional sonic log, a total porosity log, a volume of calcite log, and a volume of dolomite log.

16. The system of claim 10, wherein training the machine learning model comprises: splitting the training dataset into a training set and a testing set based on random selection;
performing cross validation by iteratively training the machine learning model; and
resampling the training set and the testing set before each iteration.

17. One or more non-transitory machine-readable storage devices storing instructions for predicting permeability in a subsurface formation, the instructions being executable by one or more processors, to cause performance of operations comprising:
obtaining well log data and core sample data from wells in the subsurface formation;
selecting input features from the well log data based on a statistical analysis of the well log data and the core sample data;
forming a training dataset including the input features and corresponding core sample data as labeled output data;
training, using the training dataset, a machine learning model; and
predicting permeability data for non-cored wells in the subsurface formation based on the trained machine learning model.

18. The one or more non-transitory machine-readable storage devices of claim 17, wherein the operations further comprise:
determining hydrocarbon reserves in the subsurface formation based at least in part on the predicted permeability data; and
in response to determining the hydrocarbon reserves, controlling equipment to produce hydrocarbons from the subsurface formation.

19. The one or more non-transitory machine-readable storage devices of claim 17, wherein the machine learning model comprises a neural network.

20. The one or more non-transitory machine-readable storage devices of claim 17, wherein the statistical analysis comprises:
determining a correlation factor between the well log data and the core sample data; and
removing data points from the well log data corresponding to permeability core sample data having values less than a specified threshold.
